(19) United States
(12) Patent Application Publication
(10) Pub. No.: US 2025/0249734 A1
(43) Pub. Date: Aug. 7, 2025

(54) MULTIPLE-PANEL FOLDING TRUCK BED COVERS

(71) Applicant: Diamondback Automotive Accessories, Inc., Philipsburg, PA (US)

(72) Inventors: Daniel N. Thompson, Sisters, OR (US); Cody Thompson Byron, Philipsburg, PA (US); Daniel J. Gongloff, Ashville, PA (US); Brandon Jacob Moist, Hummelstown, PA (US); Seth D. Barrett, Tyrone, PA (US)

(21) Appl. No.: 19/043,228

(22) Filed: Jan. 31, 2025

Related U.S. Application Data
(60) Provisional application No. 63/549,271, filed on Feb. 2, 2024.

(51) Int. Cl. B60J 7/14; B60J 7/00

(52) U.S. Cl. CPC B60J 7/141; B60J 7/0084

(57) ABSTRACT

Multiple-panel folding truck bed covers are disclosed that include front gull wing panels and middle and rear folding panels. A T-support bar provides structural support for the gull wing and middle panels, and forms a base arm of a gull wing panel hinge as well as a base arm of a middle panel compound hinge. Rain or liquid gutters may be provided in the base arms.

### CROSS-REFERENCE TO RELATED APPLICATION

This application claims the benefit of U.S. Provisional Patent Application No. 63/549,271 filed Feb. 2, 2024, which is incorporated herein by reference.

### FIELD OF THE INVENTION

The present invention relates to multiple-panel folding truck bed covers.

### BACKGROUND INFORMATION

Various types of truck bed covers, also known as tonneau covers, are known. U.S. patent application Ser. No. 18/807,668 entitled “Folding Truck Bed Covers With Self-Locking Compound Hinges”, which is incorporated herein by reference, discloses a three-panel folding truck bed cover.

### SUMMARY OF THE INVENTION

Multiple-panel folding truck bed covers are provided that include front gull wing panels and middle and rear folding panels. A T-support bar provides structural support for the gull wing and middle panels, and forms a base arm of a gull wing panel hinge as well as a base arm of a middle panel compound hinge. Rain or liquid gutters may be provided in the base arms.

An aspect of the present invention is to provide a multiple-panel folding truck bed cover comprising a T-support bar including a transverse support bar having opposing ends structured and arranged for mounting on opposing sidewall rails of a truck bed, and a longitudinal support bar having a rear end attached to the transverse support bar and a front end structured and arranged for mounting on a front wall rail of the truck bed. The truck bed cover further comprises a front left gull wing panel pivotally mounted on the longitudinal support bar by a gull wing panel hinge and contacting the transverse support bar when the front gull wing panel is in a closed position, a front right gull wing panel pivotally mounted on the longitudinal support bar by the gull wing panel hinge and contacting the transverse support bar when the second front gull wing panel is in a closed position, a middle panel pivotally mounted on the transverse support bar by a middle panel compound hinge, and a rear panel pivotally connected to the middle panel by a rear panel hinge. The transverse support bar forms a base arm of the middle panel compound hinge, and the longitudinal support bar forms a base arm of the gull wing panel hinge.

Another aspect of the present invention is to provide a T-support bar for a multiple-panel folding truck bed cover including: a transverse support bar having opposing ends structured and arranged for mounting on opposing sidewall rails of a truck bed forming a base arm of a middle panel compound hinge comprising a generally cylindrical hinge channel adjacent to a rear side of the base arm, and a base liquid gutter extending forward from a front side of the base arm; and a longitudinal support bar having a rear end attached to the front side of the base arm and a front end structured and arranged for mounting on a front wall rail of the truck bed forming a base arm of a gull wing panel hinge comprising a left generally cylindrical hinge pin extending along a left side of the longitudinal support bar, a right generally cylindrical hinge pin extending along a right side of the longitudinal support bar, a first liquid gutter adjacent to the left generally cylindrical hinge pin extending from the rear end to the front end of the longitudinal support bar, and a second liquid gutter adjacent to the right generally cylindrical hinge pin extending from the rear end to the front end of the longitudinal support bar.

A further aspect of the present invention is to provide a compound hinge for a multiple-panel folding truck bed cover comprising: a base arm structured and arranged for mounting on opposing sidewall rails of a truck bed comprising a generally cylindrical hinge channel adjacent to a rear side of the base arm; a first pivot arm comprising a generally cylindrical hinge channel adjacent to a front side of the first pivot arm; and a second pivot arm comprising a generally cylindrical front hinge pin adjacent to a front side of the second pivot arm rotatably received in the generally cylindrical hinge channel of the base arm, a generally cylindrical rear hinge pin adjacent to a rear side of the second pivot arm rotatably received in the generally cylindrical hinge channel of the first pivot arm, a front liquid gutter adjacent to the generally cylindrical front hinge pin, and a rear liquid gutter adjacent to the generally cylindrical rear hinge pin.

These and other aspects of the present invention will be more apparent from the following description.

### BRIEF DESCRIPTION OF THE DRAWINGS

FIG. 1 is a top isometric view of a multiple-panel folding truck bed cover of the invention installed on a truck bed.

FIG. 2 is a top isometric view of the multiple-panel folding truck bed cover of FIG. 1.

FIG. 3 is a bottom isometric view of the multiple-panel folding truck bed cover of FIG. 1.

FIG. 4 is an isometric view of the multiple-panel folding truck bed cover of FIG. 1, with its rear panel folded to an open position.

FIG. 5 is an isometric view of the multiple-panel folding truck bed cover of FIG. 1, with its rear and middle panels folded to an open position.

FIG. 6 is an isometric view of the multiple-panel folding truck bed cover of FIG. 1, with its right gull wing panel in a partially open position.

FIG. 7 is an isometric view of the multiple-panel folding truck bed cover of FIG. 1, with its left and right gull wing panels in partially open positions.

FIG. 8 is an isometric view of the multiple-panel folding truck bed cover of FIG. 1, with the rear and middle panels in a partially open position, and the left and right gull wing panels in partially open positions.

FIG. 9 is a top isometric view of a T-support bar of a multiple-panel folding truck bed cover installed on front and sidewall rails of a truck bed.

FIG. 10 is a top isometric view of the T-support bar of FIG. 9.

FIG. 11 is a bottom isometric view of the T-support bar of FIG. 9.

FIG. 12 is a top isometric view of the T-support bar of FIG. 9, with a pivot arm rotatably mounted thereon to provide a hinge joint.

FIG. 13 is a side view of the hinge joint of FIG. 12 showing the hinge in a flat or closed position.

FIG. 14 is a side view of the hinge joint of FIG. 13 in a partially open position.

FIG. 15 is a side view of the hinge joint of FIG. 13 in a fully open position.

FIG. 16 is a side view of the multiple-panel folding truck bed cover of FIG. 1, with the rear and middle panels folded into an open position, and the gull wing panels in closed positions.

FIG. 17 is a side view of a rear panel hinge between the rear and middle panels of a multiple-panel folding truck bed cover.

FIG. 18 is a side view of a multiple-panel folding truck bed cover, with the rear and middle panels closed, and the left gull wing panel slightly raised to a partially open position.

FIG. 19 is an isometric view of the truck bed cover of FIG. 18, with the left gull wing panel in the partially open position.

FIG. 19A is a magnified view of a portion of the truck bed cover of FIG. 19 illustrating details of a compound hinge between the middle panel and the front gull wing panels.

FIG. 20 is a front view of a gull wing panel hinge between the left and right gull wing panels.

FIG. 20A is a magnified view of a portion of FIG. 20 illustrating details of the gull wing panel hinge in its closed or flat position.

FIG. 21 is a front view of the gull wing panel hinge of FIG. 20, with the left and right gull wing panels in partially open positions.

FIG. 21A is a magnified view of a portion of the gull wing panel hinge of FIG. 21 in the partially open position.

FIG. 22 is a side view of the rear panel hinge of a multiple-panel folding truck bed cover in a flat or closed position.

FIG. 23 is a side view of the rear panel hinge of FIG. 22 in a partially open position.

FIG. 24 is a side view of the rear panel hinge of FIG. 22 in a fully folded or open position.

FIG. 25 is a side view of the middle panel compound hinge of a multiple-panel folding truck bed cover in a flat or closed position.

FIG. 26 is a side view of the middle panel compound hinge of FIG. 25 in a partially open position.

FIG. 27 is a side view of the middle panel compound hinge of FIG. 25 in a fully folded or open position.

FIG. 28 is a front view of the gull wing panel hinge of a multiple-panel folding truck bed cover in a flat or closed position.

FIG. 29 is a front view of the gull wing panel hinge of FIG. 28 a left pivot arm in a partially open position.

FIG. 30 is a front view of the gull wing panel hinge of FIG. 28 with left and right pivot arms in partially open positions.

### DETAILED DESCRIPTION

The present invention provides multiple-panel folding truck bed covers including front longitudinally hinged gull wing panels, and transversely hinged middle and rear panels. A T-support bar provides structural support for the gull wing and middle panels. The gull wing, middle and rear panels may be load-bearing panels capable of holding significant amounts of weight, e.g., for hauling various types of equipment and/or tools thereon.

To open the truck bed cover, the rear panel may be folded over the middle panel, then the folded middle and rear panels may be folded over the closed front gull wing panels. A front edge of the rear panel may be pivotally mounted to a rear edge of the middle panel by a rear panel hinge having a base arm that includes a rain or liquid gutter. A front edge of the middle panel may be rotationally mounted on the T-support bar, which forms a base arm of a middle panel compound hinge. The middle panel compound hinge includes first and second pivot arms that permit the folded rear and middle panels to fold onto the top outer surface of the front gull wing panels, with the bottom inner surface of the rear panel resting on the top outer surface of the front gull wing panels. The second pivot arm of the middle panel compound hinge may include at least one liquid gutter to collect and direct rain water and other liquids to the sidewall rails of the truck bed. The T-support bar also forms a base arm of a gull wing panel hinge that allows the front gull wing panels to rotate from closed to open positions. The base arm of the gull wing panel hinge may include a liquid gutter to collect and direct rain water and other liquids to the front wall rail of the truck bed.

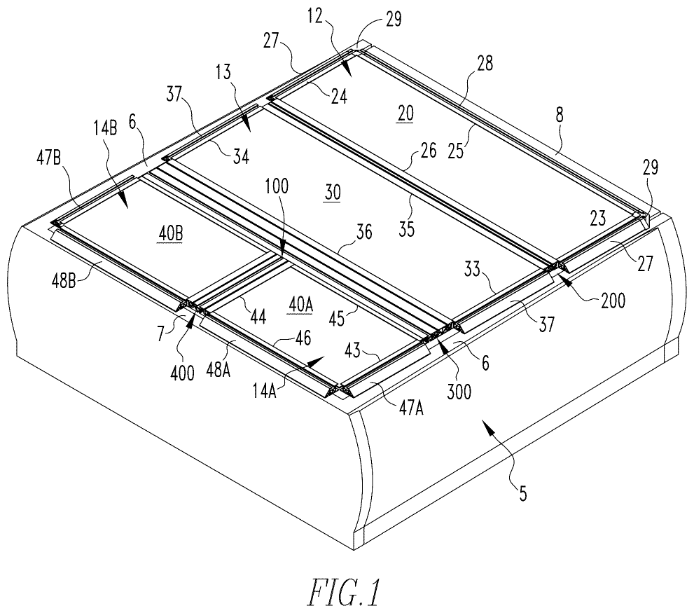

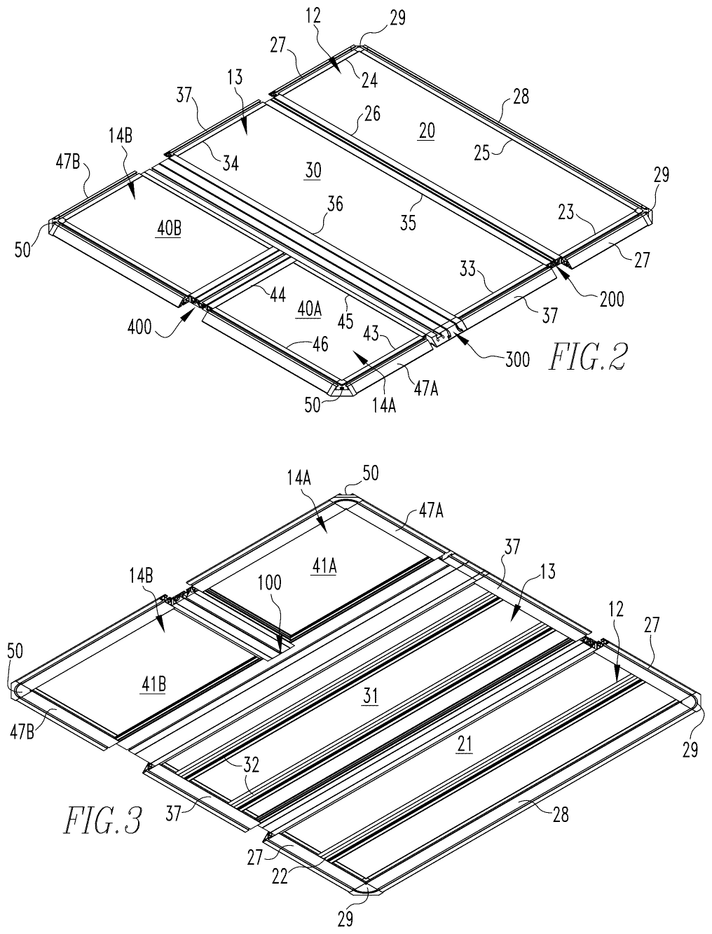

FIG. 1 illustrates a multiple-panel folding truck bed cover 10 of the present invention mounted on a truck bed 5. FIG. 2 is a top isometric view, and FIG. 3 is a bottom isometric view of the multiple-panel folding truck bed cover 10. The truck bed cover 10 includes a rear panel 12, a middle panel 13, a front left gull wing panel 14A, and a front right gull wing panel 14B. In FIG. 1, the rear, middle and gull wing panels 12, 13, 14A and 14B are in closed positions on the truck bed 5 in which the rear and middle panels 12 and 13 are supported on sidewall rails 6, and the left and right gull wing panels 14A and 14B are supported by the sidewall rails 6 and by a front wall rail 7. The truck bed 5 also includes a tailgate rail 8.

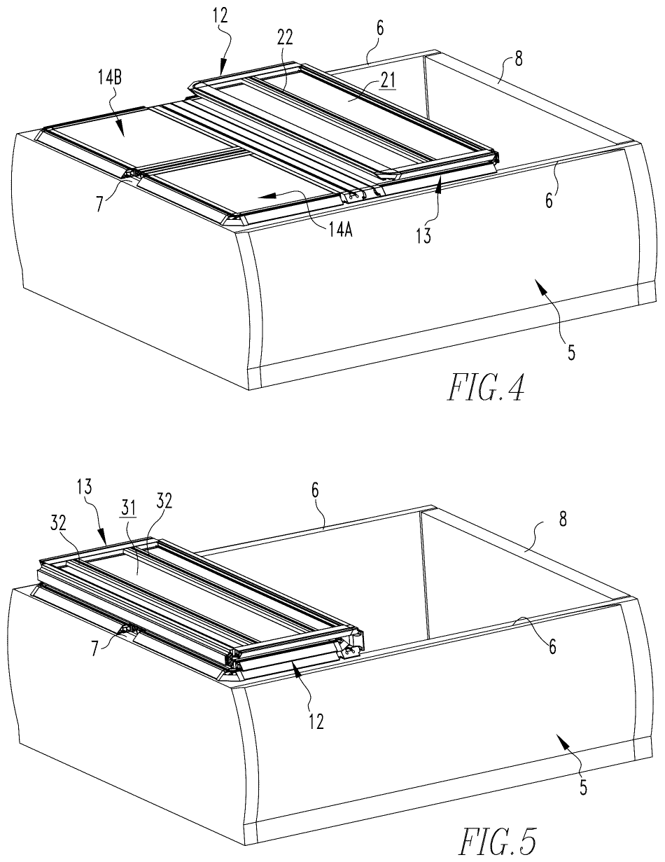

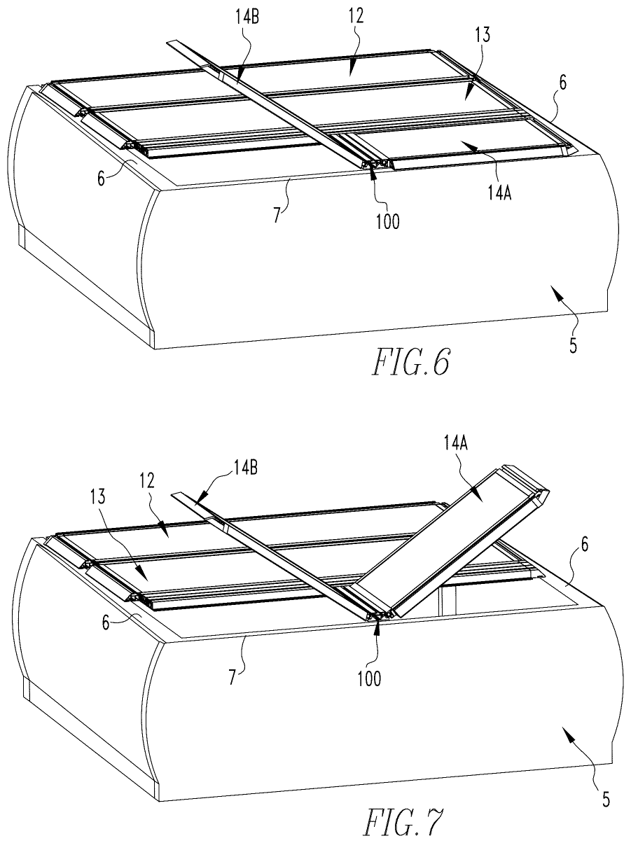

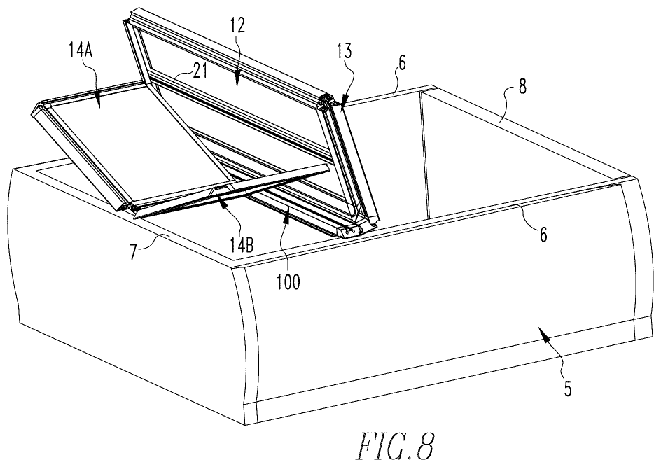

FIGS. 4-8 show the truck bed cover 10 in various configurations in which the rear, middle, left gull wing and right gull wing panels 12, 13, 14B and 14B are in various open positions. In FIG. 4, the rear panel 12 is folded onto the middle panel 13. In FIG. 5, the rear and middle panels 12 and 13 are folded onto the left and right gull wing panels 14A and 14B. In FIG. 6, the rear and middle panels are in closed positions, and the right gull wing panel 14B is partially open. In FIG. 7, both the left and right gull wing panels 14A and 14B are partially open. In FIG. 8, the left and right gull wing panels 14A and 14B are partially open, and the rear and middle panels 12 and 13 are also in open positions.

As shown in FIGS. 1-3, the rear panel 12 of the multiple-panel folding truck bed cover 10 includes a rear panel insert 20 having a top surface, a rear panel insert bottom surface 21, and a rear panel support stud 22 attached to the bottom surface 21. The rear panel insert 20 has a left side edge 23, a right side edge 24, a rear edge 25, and a front edge 26. The edges of the rear panel insert 20 are received within support rails, with the left and right side edges 23 and 24 received within side rails 27, and the rear edge 25 received within a rear panel rear rail 28. As more fully described below, the front edge 26 of the rear panel insert 20 is received within a pivot arm 210 of a rear panel hinge 200. When the rear panel 12 is in a closed position, the rear panel side rails 27 help support the rear panel 12 on the sidewall rails 6 of the truck bed 5. Rear corner caps 29 are provided at the intersections between the rear panel side rails 27 and the rear panel rear rail 28.

As further shown in FIGS. 1-3, the middle panel 13 includes a middle panel insert 30 having top surface, a middle panel insert bottom surface 31, and middle panel support studs 32 attached to the bottom surface 31. The middle panel insert 30 includes a left side edge 33, a right side edge 34, a rear edge 35, and a front edge 36. The left and right side edges 33 and 34 of the middle panel insert 30 are received within middle panel side rails 37. When the middle panel 13 is in a closed position, the middle panel side rails 37 help support the middle panel 13 on the sidewall rails 6 of the truck bed 5.

As further shown in FIGS. 1-3, the front left gull wing panel 14A includes a left gull wing panel insert 40A having a top surface and a left gull wing panel insert bottom surface 41A. The right gull wing panel 14B includes a right gull wing panel insert 40B having top surface and a right gull wing panel insert bottom surface 41B. Each of the left and right gull wing panel inserts 40A and 40B include a gull wing panel exterior edge 43, a gull wing panel interior edge 44, a gull wing panel rear edge 45, and a gull wing panel front edge 46. The exterior edge 43 of the left gull wing panel insert 40A is received within a gull wing panel left side rail 47A, while the exterior edge 43 of the right gull wing panel insert 40B is received in a gull wing panel right side rail 47B. The gull wing panel front edge 46 of the left gull wing panel insert 40A is received within a gull wing panel left front rail 48A, while the gull wing panel front edge 46 of the right gull wing panel insert 40B is received in a gull wing panel right front rail 48B. The gull wing panel rear edge 45 of the left gull wing panel insert 40A is received within a gull wing panel left rear rail 49A, while the rear edge 45 of the right gull wing panel insert 40B is received in a gull wing panel right rear rail 49B. Front corner caps 50 are installed at intersections between the gull wing panel left side rail 47A and front rail 48A, and between the gull wing panel right side rail 47B and right front rail 48B.

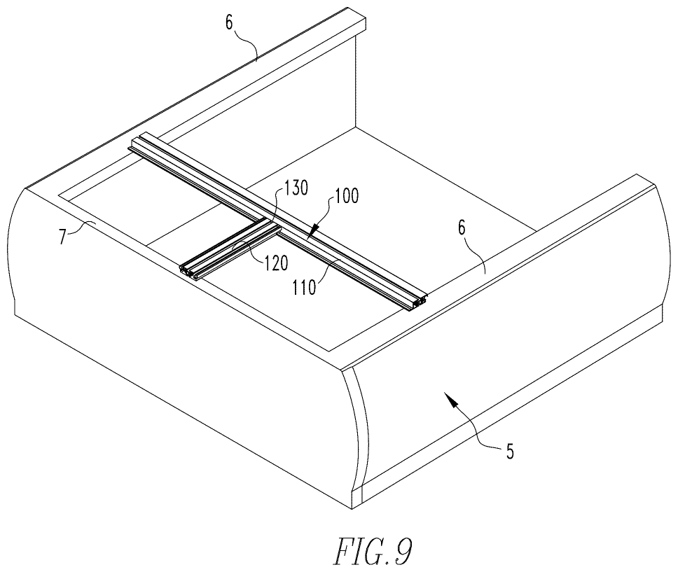

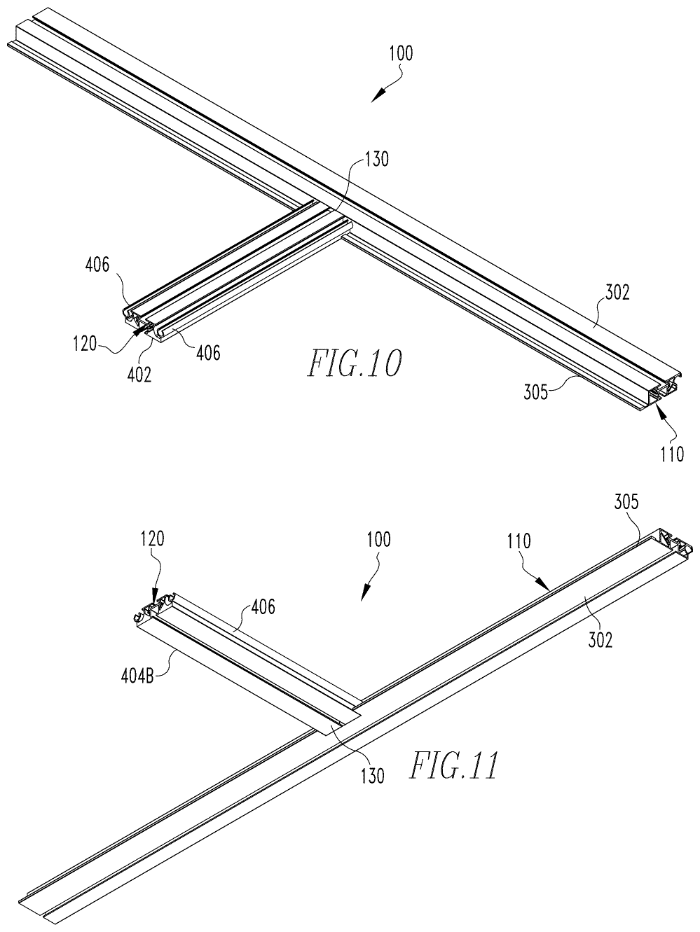

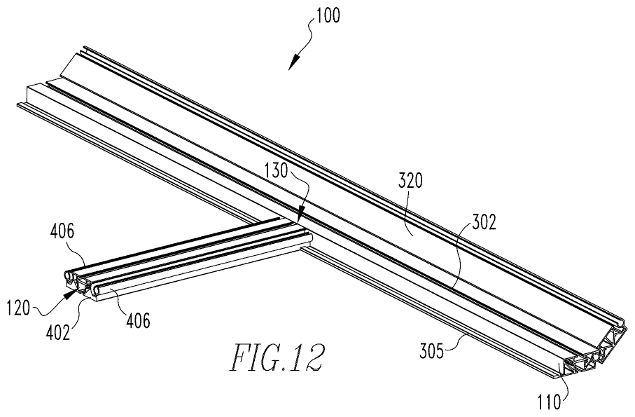

FIG. 9 illustrates a T-support bar 100 installed on and supported by the sidewall rails 6 and the front wall rail 7 of the truck bed 5. FIG. 10 is a top isometric view of the T-support bar 100, and FIG. 11 is a bottom isometric view of the T-support bar. FIG. 12 is a top isometric view of the T-support bar 100 with a pivot arm 320 of a middle panel compound hinge rotatably mounted thereon, as more fully described below. The T-support bar 100 includes a transverse support bar 110 secured to a longitudinal support bar 120 at a T-joint 130. The T-joint 130 may be welded, mechanically fastened, or the like. The longitudinal support bar 120 includes a central support pillar 121, side support rails 122, a lower slot 123, an upper tie-down channel 124, and eye holes 125 for receiving an end cap. As shown in FIG. 9, the ends of the transverse support bar 110 are supported by the sidewall rails 6, and a front end of the longitudinal support bar 120 is supported on the front wall rail 7.

In addition to providing support for the multiple-panel folding truck bed cover 10 on the sidewall rails 6 and front wall rail 7, the T-support bar 100 provides base arms for a compound hinge 300 connected to the middle panel 13, and for hinges connected to the left and right gull wing panels 14A and 14B. Specifically, as more fully described below, the transverse support bar 110 of the T-support bar 100 serves as a base arm 302 of the middle panel compound hinge 300, and the longitudinal support bar 120 serves as a base arm of a gull wing panel hinge 400. As further described below, the transverse and longitudinal supports bars 110 and 120 of the T-support bar 100 also provide rain gutters in the region between the middle panel 13 and the gull wing panels 14A, 14B, and in the region between each of the left and right gull wing panels 14A and 14B.

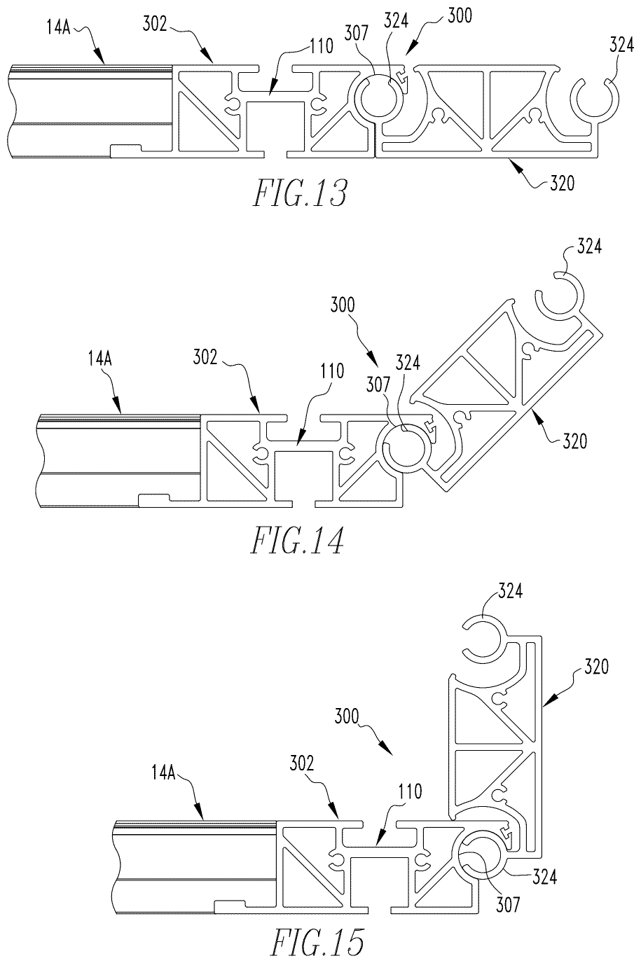

FIGS. 13-15 illustrate details of the transverse support bar 110, which serves as the base arm 302 of the middle panel compound hinge 300, and also serves to support the left gull wing panel 14A and the right gull wing panel 14B when in their closed positions. As more fully described below, the middle panel compound hinge 300 includes a second pivot arm 320 that is rotatably attached to the base arm 302. In FIG. 13, the second pivot arm 320 is in a flat position in which the ends of the second pivot arm 320 rest on the sidewall rails 6 of the truck bed 5. In FIG. 14, the second pivot arm has been rotated to a partially open position. In FIG. 15, the second pivot arm 320 has been rotated to a fully open position.

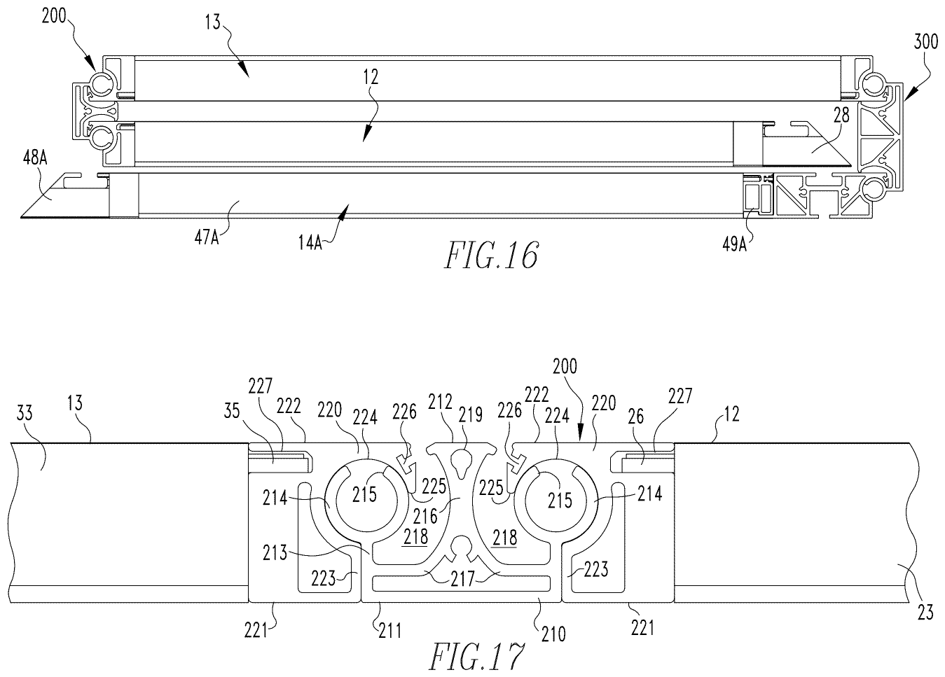

FIG. 16 is a side view illustrating the rear panel 12 and middle panel 13 in their folded, fully open positions. In the position shown, the rear panel hinge 200 is in a fully open position, and the middle panel compound hinge 300 is in a fully open position. As shown, the left gull wing panel 14A is in the closed position in which the gull wing panel left front rail 48A can contact and be supported by the front wall rail 7 of the truck bed 5, and the gull wing panel left side rail 47A can contact and be supported by the sidewall rail 6. Furthermore, in the closed position, the gull wing panel left rear rail 49A contacts and is supported by the base arm 302 of the middle panel compound hinge 300.

FIG. 17 illustrates the rear panel hinge 200 which connects the rear panel 12 to the middle panel 13. The rear panel hinge 200 includes a base arm 210 having a bottom surface 211 and a top surface 212. A support arm 213 extends from the bottom surface 211 to a cylindrical hinge pin 214 having an open slot 215 extending along its length. A central support pillar 216 extends from the top surface 212 to support legs 217 located above the bottom surface 211 and extending to the support arms 213. The top surfaces of the support legs 217 form the floor of liquid gutters 218 that may collect and direct rain water or other liquids toward the sidewall rails 6, as more fully described below. At least one eye hole 219 is provided in the central support pillar 216 for receiving an end cap.

As further shown in FIG. 17, pivot arms 220 are provided on opposite sides of the base arm 210. Each pivot arm 220 includes a bottom surface 221 and a top surface 222. A support wall 223 extends from the bottom surface 221 to a cylindrical hinge channel 224 having a lip opening 225. A seal channel 226 is provided in the pivot arm 220 between the top surface 222 and the lip opening 225. Each pivot arm 220 includes a panel-receiving channel 227 which receives either the front edge 26 of the rear panel insert 20, or the rear edge 35 of the middle panel insert 30.

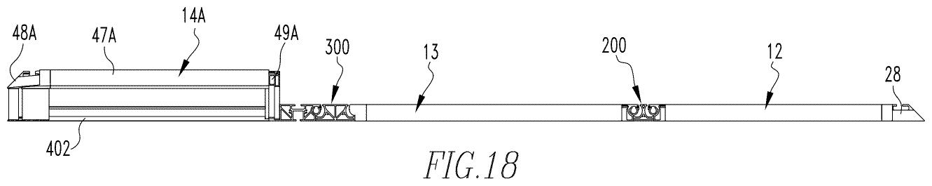

FIGS. 18 and 19 illustrate the multiple-panel folding truck bed cover 10 with the rear panel hinge 200 and middle panel compound hinge 300 in their flat positions for support on the sidewall rails 6 when the rear middle panels 12 and 13 are in their closed positions. As further shown in FIGS. 18, 19 and 19A, the left gull wing panel 14A may be raised from its closed position to an open position. The left rear rail 49A of the left gull wing panel 14A is raised from the base arm 302 of the middle panel compound hinge 300. As shown most clearly in FIG. 19A, the base arm 302 includes a base gutter 305 having a raised gutter lip 306. When the left gull wing panel 14A is in its closed position, the left rear rail 49A bottom surface contacts and is supported by the gutter lip 306 of the base arm 302. The base gutter 305 allows rainwater or other liquids to be collected and directed toward the sidewall rail 6 when the left gull wing panel 14A is in its closed position. The base arm 302 of the middle panel compound hinge 300, which also corresponds to the transverse support bar 110 of the T-support bar 100, thus provides structural support for the left and right gull wing panels 14A and 14B, and acts as a liquid gutter to collect and direct liquids to the sidewall rails 6.

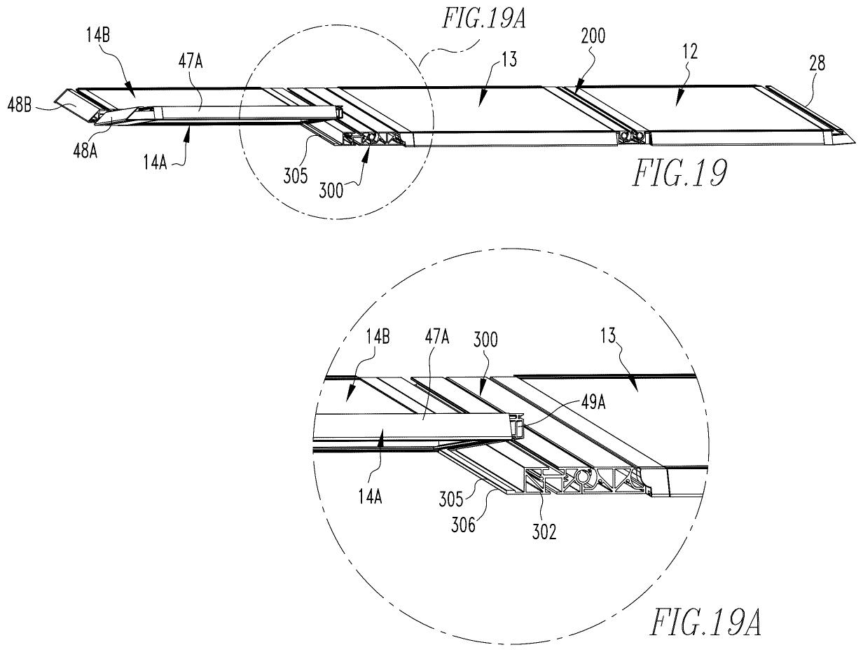

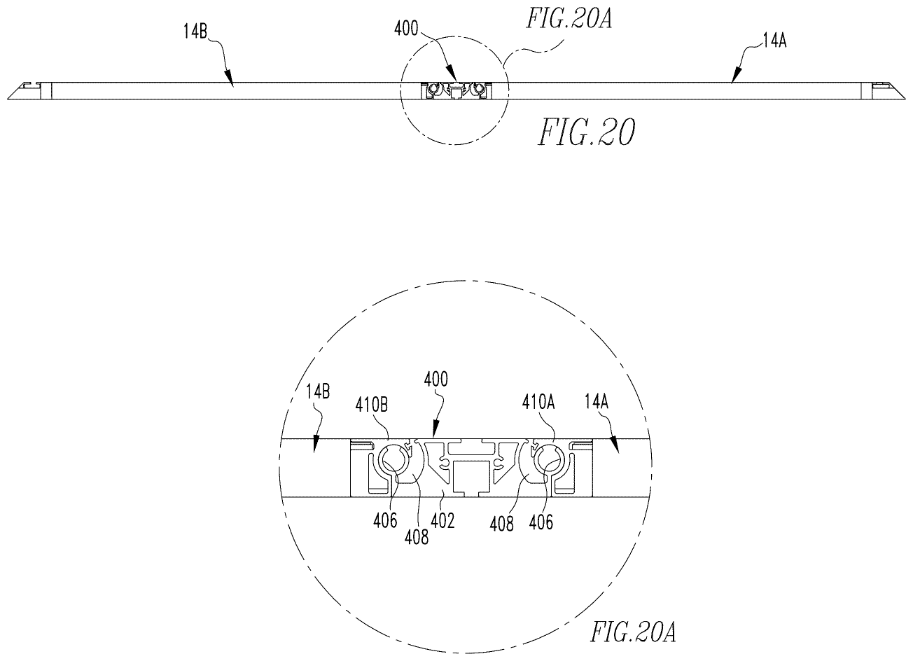

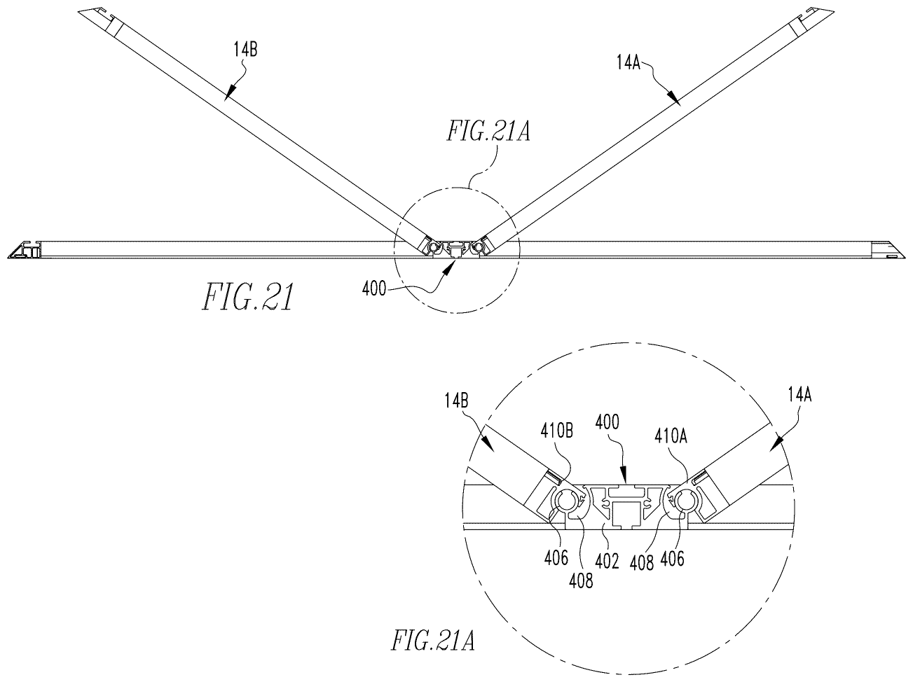

FIGS. 20 and 21 are front views of the gull wing panel hinge 400 attached to the left and right gull wing panels 14A and 14B. In FIG. 20, the gull wing panel hinge 400 is in a flat or closed position, and in FIG. 21, the gull wing panel hinge 400 is in an open position. The gull wing panel hinge 400 includes a base arm 402, which corresponds to the longitudinal support bar 120 of the T-support bar 100. A left pivot arm 410A is rotatably attached to one side of the base arm 402, and a right pivot arm 410B is rotatably attached to the other side of the base arm 402. As more fully described below, the base arm 402, not only provides structural support for the left and right gull wing panels 14A and 14B, but also provides longitudinal liquid gutters 408 that collect and direct rainwater or other liquids to the front wall rail 7.

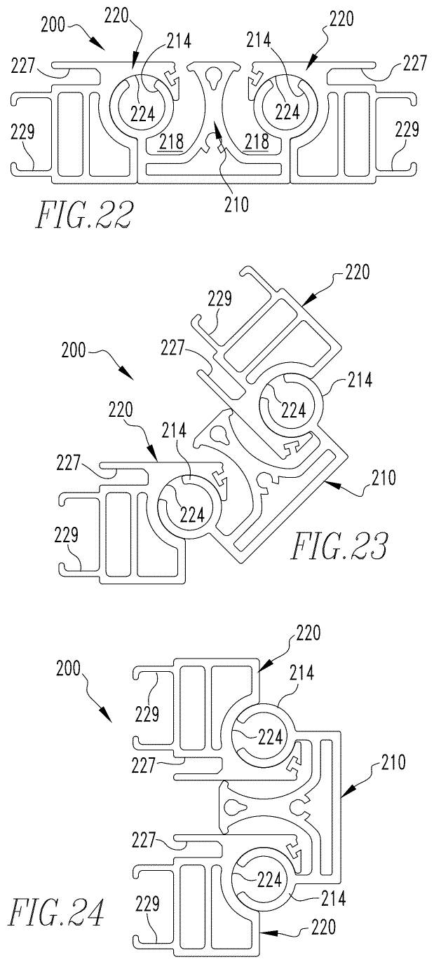

FIGS. 22-24 illustrate additional features of the rear panel hinge 200 shown in FIG. 17, with the hinge 200 in closed, partially open, and fully open positions, respectively. As each pivot arm 220 rotates in relation to the base arm 210, the inner surface of the cylindrical hinge channel 224 moves in relation to the outer surface of the cylindrical hinge pin 214. The base arm 210 includes the base gutters 218, which are partially formed by the support arms 213 for the hinge pins 214. Each pivot arm 220 includes a side tie-down channel 229. When the rear panel hinge 200 is in the flat closed position of FIG. 22, the side tie-down channels 219 may be used to secure clamps, tool bars and other equipment under the truck bed cover 10.

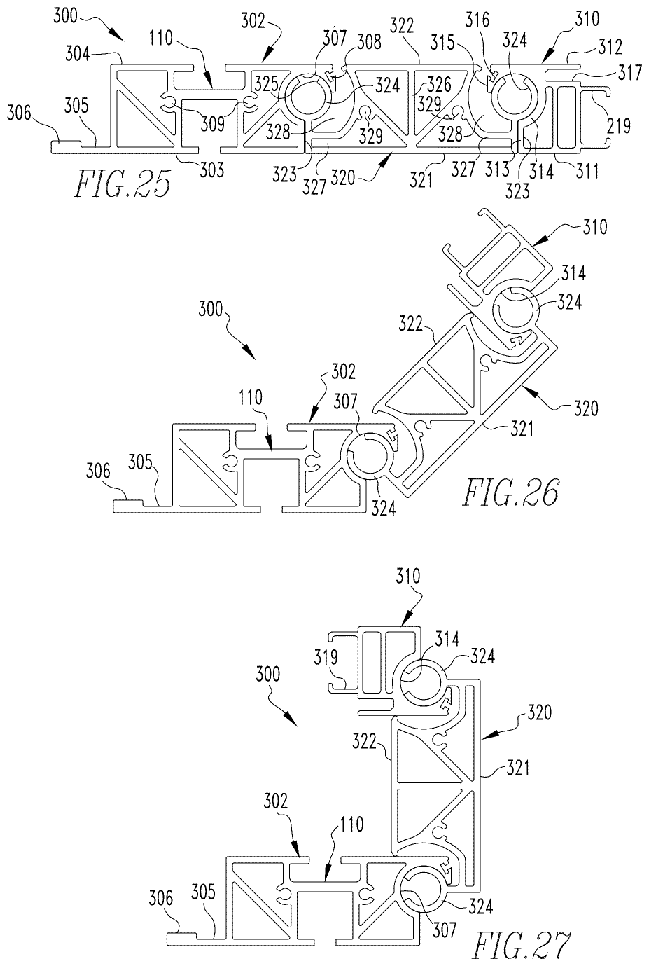

FIGS. 25-27 illustrate features of the middle panel compound hinge 300 in closed, partially open, and fully open positions, respectively. The middle panel compound hinge 300 includes a base arm 302 with a bottom surface 303 and top surface 304. As described previously, a base gutter 305 and gutter lip 306 are located at a front edge of the bottom surface 303. A cylindrical hinge channel 307 is provided below the top surface 304. A seal channel 308, and eye holes for receiving an end cap 309, are provided in the base arm 302.

As further illustrated in FIGS. 25-27, the first pivot arm 310 includes a bottom surface 311 and a top surface 312. A support wall 313 extends from the bottom surface 311 to a cylindrical hinge channel 314 with a lip opening 315. A seal channel 316 is provided in the first pivot arm 310. A panel insert-receiving channel 317 is located under the top surface 312. A tie-down channel 319 is provided on a rear facing side of the first pivot arm 310.

As further shown in FIGS. 25-27, the second pivot arm 320 includes a bottom surface 321 and a top surface 322. A support wall 323 extends from the bottom surface 321 to a cylindrical hinge pin 324 with an open slot 325. The second pivot arm 320 includes a central support pillar 326 and side support legs 327. The side support legs 327, in combination with the support walls 323 for the hinge pins 324, form liquid gutters 328 that may collect rainwater or other liquids and direct such liquids to the sidewall rails 6. Eye holes 329 are provided in the second pivot arm 320 for receiving an end cap.

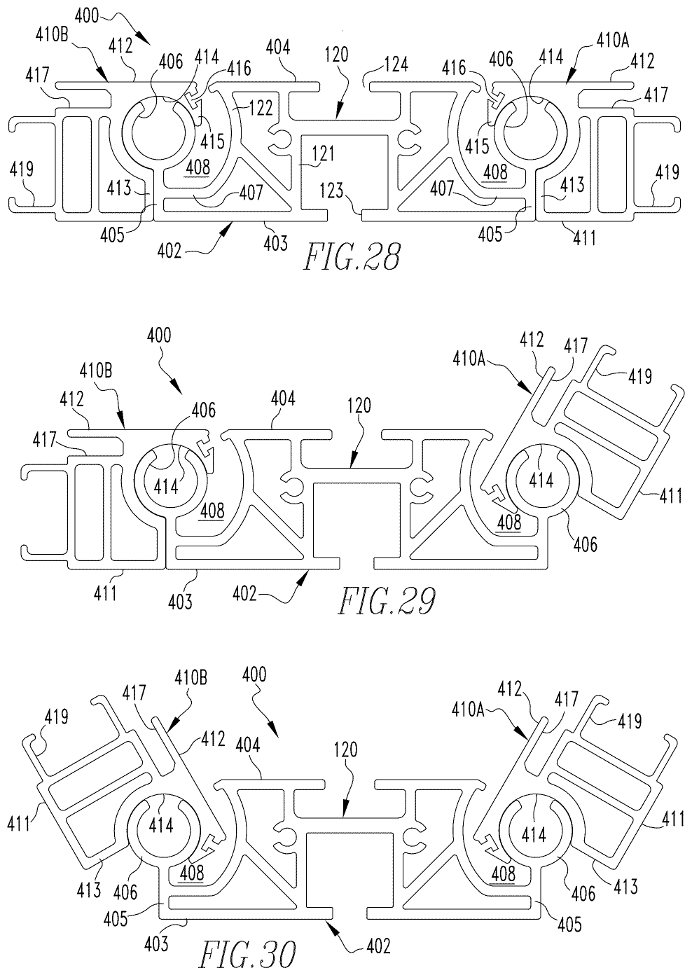

FIGS. 28-30 illustrate details of the gull wing panel hinge 400 in closed, partially open, and fully open positions, respectively. The gull wing panel hinge 400 includes a base arm 402 with the left pivot arm 410A rotatably attached to one side, and the right pivot arm 410B rotatably attached to the other side. The base arm 402 includes a bottom surface 403 and a top surface 404. A support arm 405 extends from the bottom surface 403 to a cylindrical hinge pin 406. A pillar support leg 407 extends laterally from the central support pillar 121 to the hinge pin support arm 405. The pillar support leg 407, along with the support arm 405 for the hinge pin 406, forms a liquid gutter 408 that may collect rainwater and other liquids and direct such liquids toward the front wall rail 7.

Each of the left and right pivot arms 410A and 410B include a bottom surface 411 and top surface 412. A support wall 413 extends from the bottom surface 411 to a cylindrical hinge channel 414 having a lip opening 415. A seal channel 416 is provided between the lip opening 415 and the top surface 412. A panel insert-receiving channel 417 is provided under the top surface 412. A tie-down channel 419 is provided on the side of each of left and right pivot arms 410A and 410B.

The various seal channels 226, 308, 316 and 416 may have any suitable type of resilient or elastomeric sealing strip (not shown) inserted therein, for example, a T-shaped portion held within the channel with a solid or hollow cylindrical portion extending therefrom for contacting and sealing against an opposing edge of an adjacent hinge component.

The end caps and corner caps may be made of any suitable materials such as rigid plastics or metals such as aluminum. The end caps may include channels or openings that direct or allow rain water or other liquids to flow from the various gutters over the sidewall rails 6 or front wall rail 7.

The various rail, stud, support bar and base arm components may comprise extrusions made from aluminum or any other suitable material, and the panel inserts may be made of aluminum sheet of any desired thickness or any other suitable material. The extrusions and/or sheet panel inserts may be coated with any suitable coatings, films, and the like. The panel inserts may be secured in their respective receiving channels by any suitable means such as adhesives, welding, mechanical fasteners, press fitting, and the like.

The support studs 22 and 32 mounted on the underside of the cover may be secured to the cover by any suitable means such as welding, mechanical fasteners, mechanical interlocking, adhesives and the like. The support studs 22 and 32 may include a base, side channels and a central slide fastener-receiving channel forming a central slot opening similar to the toolbar support rail described in U.S. application Ser. No. 17/852,271, which is incorporated herein by reference.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A multiple-panel folding truck bed cover comprising:
a T-support bar comprising:
a transverse support bar having opposing ends structured and arranged for mounting on opposing sidewall rails of a truck bed; and
a longitudinal support bar having a rear end attached to the transverse support bar and a front end structured and arranged for mounting on a front wall rail of the truck bed;
a front left gull wing panel pivotally mounted on the longitudinal support bar by a gull wing panel hinge and contacting the transverse support bar when the front gull wing panel is in a closed position;
a front right gull wing panel pivotally mounted on the longitudinal support bar by the gull wing panel hinge and contacting the transverse support bar when the second front gull wing panel is in a closed position;
a middle panel pivotally mounted on the transverse support bar by a middle panel compound hinge; and
a rear panel pivotally connected to the middle panel by a rear panel hinge, wherein:
the transverse support bar forms a base arm of the middle panel compound hinge, and
the longitudinal support bar forms a base arm of the gull wing panel hinge.

2. The multiple-panel folding truck bed cover of claim 1, wherein the base arm of the gull wing panel hinge comprises at least one liquid gutter structured and arranged to collect and direct liquid to the front wall rail.

3. The multiple-panel folding truck bed cover of claim 2, wherein the base arm of the gull wing panel hinge comprises two of the liquid gutters.

4. The multiple-panel folding truck bed cover of claim 1, wherein the base arm of the middle panel compound hinge comprises a base gutter structured and arranged to collect and direct liquid to the sidewall rails.

5. The multiple-panel folding truck bed cover of claim 1, wherein the rear panel hinge comprises a base arm comprising at least one liquid gutter structured and arranged to collect and direct liquid to the sidewall rails.

6. The multiple-panel folding truck bed cover of claim 5, wherein the base arm of the rear panel hinge comprises two of the liquid gutters.

7. The multiple-panel folding truck bed cover of claim 1, wherein the gull wing panel hinge comprises:
a left pivot arm rotatably attached to the base arm of the gull wing panel hinge and receiving a left gull wing panet insert; and
a right pivot arm rotatably attached to the base arm of the gull wing panel hinge and receiving a right gull wing panel insert.

8. The multiple-panel folding truck bed cover of claim 7, wherein the base arm, left pivot arm, and right pivot arm of the gull wing panel hinge comprise aluminum extrusions.

9. The multiple-panel folding truck bed cover of claim 1, wherein the middle panel compound hinge comprises:
a first pivot arm attached to the middle panel; and
a second pivot arm rotatably attached to the first pivot arm and rotatably attached to the base arm of the middle panel compound hinge.

10. The multiple-panel folding truck bed cover of claim 9, wherein the second pivot arm of the middle panel compound hinge comprises at least one liquid gutter structured and arranged to collect and direct liquid to the sidewall rails.

11. The multiple-panel folding truck bed cover of claim 10, wherein the second pivot arm of the middle panel compound hinge comprises two of the liquid gutters.

12. The multiple-panel folding truck bed cover of claim 10, wherein the base arm, the first pivot arm, and the second pivot arm of the middle panel compound hinge comprise aluminum extrusions.

13. A T-support bar for a multiple-panel folding truck bed cover comprising:
a transverse support bar having opposing ends structured and arranged for mounting on opposing sidewall rails of a truck bed forming a base arm of a middle panel compound hinge comprising:
a generally cylindrical hinge channel adjacent to a rear side of the base arm; and
a base liquid gutter extending forward from a front side of the base arm; and
a longitudinal support bar having a rear end attached to the front side of the base arm and a front end structured and arranged for mounting on a front wall rail of the truck bed forming a base arm of a gull wing panel hinge comprising:
a left generally cylindrical hinge pin extending along a left side of the longitudinal support bar;
a right generally cylindrical hinge pin extending along a right side of the longitudinal support bar;
a first liquid gutter adjacent to the left generally cylindrical hinge pin extending from the rear end to the front end of the longitudinal support bar; and
a second liquid gutter adjacent to the right generally cylindrical hinge pin extending from the rear end to the front end of the longitudinal support bar.

14. A compound hinge for a multiple-panel folding truck bed cover comprising:
a base arm structured and arranged for mounting on opposing sidewall rails of a truck bed comprising a generally cylindrical hinge channel adjacent to a rear side of the base arm;
a first pivot arm comprising a generally cylindrical hinge channel adjacent to a front side of the first pivot arm; and
a second pivot arm comprising:
a generally cylindrical front hinge pin adjacent to a front side of the second pivot arm rotatably received in the generally cylindrical hinge channel of the base arm;
a generally cylindrical rear hinge pin adjacent to a rear side of the second pivot arm rotatably received in the generally cylindrical hinge channel of the first pivot arm;
a front liquid gutter adjacent to the generally cylindrical front hinge pin; and
a rear liquid gutter adjacent to the generally cylindrical rear hinge pin.
